(19) United States
(12) Patent Application Publication
(10) Pub. No.: US 2008/0142620 A1
(43) Pub. Date: Jun. 19, 2008

(54) NOZZLE FOR A SPRAY HEAD

(75) Inventors: ERNST SCHEIDT, Dachau (DE); Stefan Hobelsberger, Neufahrn (DE)

Correspondence Address: Henry M. Feiereisen;Henry M. Feiereisen, LLC, Suite 4714, 350 Fifth Avenue, New York, NY, 10118, US

(73) Assignee: KraussMaffei Technologies GmbH, Munchen (DE)

(21) Appl. No.: 12/024,501

(22) Filed: Feb. 1, 2008

Related U.S. Application Data
(63) Continuation of application No. PCT/EP2006/063904, filed on Jul. 5, 2006.

(30) Foreign Application Priority Data
Aug. 11, 2005 (DE) 10 2005 037 972.9

(51) Int. Cl. B05B 1/34

(52) U.S. Cl. 239/490

(57) ABSTRACT

A nozzle for a spray head includes a nozzle body having a cavity which can be supplied with discharge material via a material feed and in which a swirl-inducing body is arranged which has arranged on it a nozzle insert with a nozzle bore via which the discharge material can be sprayed out. The swirl-inducing body has a disk or plate-shaped base on which an annular web is arranged, with the base being breached by at least one through opening which is arranged radially outside the annular web. The annular web is breached at least one point radially from the outside to the inside by at least one substantially straight or helical groove, and the swirl-inducing body and the nozzle insert are arranged in the nozzle body.

### CROSS-REFERENCES TO RELATED APPLICATIONS

This application is a continuation of prior filed copending PCT International application no. PCT/EP2006/063904, filed Jul. 5, 2006, which designated the United States and has been published but not in English as International Publication No. WO 2007/017319 and on which priority is claimed under 35 U.S.C. §120, and which claims the priority of German Patent Application, Serial No. 102005037972.9, filed Aug. 11, 2005, pursuant to 35 U.S.C. 119(a)-(d), the contents of which are incorporated herein by reference in its entirety as if fully set forth herein.

### BACKGROUND OF THE INVENTION

The present invention relates, in general, to a nozzle for a spray head, and more particularly to a spray head of a polyurethane mixing head.

Nothing in the following discussion of the state of the art is to be construed as an admission of prior art.

U.S. Pat. No. 5,028,006, issued Jul. 2, 1991 to De Winter et al. discloses a spray nozzle for spray gun for forming a polyurethane layer on a surface by spraying the reaction components for obtaining this polyurethane. A spray piece with a funnel-shaped cavity is connected to a supply channel of the reaction components and flows out in a cylindrical channel which connects this cavity to a spray through opening. A core is detachably placed in the spray piece and allows the reaction components and/or the already formed polyurethane to be fed according to a screw or whirling movement through the spray opening. The core has a conical part which rests against an inner conical wall of the cavity. Formed in the conical core part are spiraled grooves which impart a screw or whirling motion to the reaction components and which are in communication with respective core borings which open into the supply channel at a common point. A funnel-shaped diffuser is connected to the spray opening to realize a divergent liquid jet, the core having slanting borings which extend from the supply channel to the grooves.

It would be desirable and advantageous to provide an improved nozzle for a spray head, in particular of a polyurethane mixing head, to obviate prior art shortcomings.

### SUMMARY OF THE INVENTION

According to one aspect of the present invention, a nozzle for a spray head, in particular of a polyurethane mixing head, includes a nozzle body having a cavity receiving discharge material via a material feed, a swirl-inducing body accommodated in the nozzle body and having a disk or plate-shaped base constructed to include an annular web and at least one through opening arranged radially outside the annular web to provide a passage in fluid communication with the material feed, wherein the annular web is breached by a groove extending radially from an outer circumference to an inner circumference, and a nozzle insert disposed on the swirl-inducing body and having a nozzle bore via which the discharge material is sprayed out, wherein the base and the nozzle insert define radially outside of the annular web an annular channel which is fluidly connected to the through opening, wherein a swirl chamber is formed radially within the annular web for fluidly connecting the swirl chamber with the annular channel via the groove, and wherein the swirl chamber is covered by the nozzle insert such that discharge material is able to exit the swirl chamber via the nozzle bore during operation.

The present invention resolves prior art problems by feeding discharge material to the nozzle body via a material feed from where the discharge material flows in the direction of the through opening (or through openings) and ultimately enters via an annular space outside the annular web and the groove (or grooves) into the swirl chamber. A swirling motion is hereby imparted to the discharge material which receives a rotational speed component and is sprayed out via the nozzle bore. The swirling motion and the shape of the nozzle bore result in an optimum discharge cone. Tests have shown superior spraying results, using the nozzle according to the invention. This may be attributed, i.a., to the substantially radial flow of discharge material from the annular web into the swirl chamber to effect a superior swirling action.

According to another feature of the present invention, the groove may be helical or straight.

According to another feature of the present invention, the base may have a plurality of through openings disposed in circumferential spaced-apart relationship of the base. The through openings may be configured in the form of bores or circumferential grooves in the base of the swirl-inducing body. Bores and grooves are easy to make. Suitably, the through openings may extend at an incline in relation to a vertical upon the base so that the discharge material is introduced in circumferential direction of the annular channel to thereby impart a swirling motion to the discharge material as the discharge material passes the through openings and enters the radially outer annular channel. Suitably, the incline of the through openings and the shape of the grooves are suited to one another such as to attain an optimum swirling effect. In order to intensify the swirling effect in the radially outer annular channel as well as in the swirl chamber, the through openings and the grooves can be placed in offset relationship about the circumference of the swirl-inducing body. As a result, discharge material passing the through openings is prevented from flowing through the grooves immediately thereafter; rather the discharge material is forced to flow at least along a portion of the circumferential radially outer annular channel.

A nozzle according to the invention is easy to make and easy to install and to service. Suitably, the swirl-inducing body and the nozzle insert are detachably installed. The nozzle insert may hereby be constructed for threaded engagement into the nozzle body, thereby also restraining the swirl-inducing body in the nozzle body. As a result, the nozzle body, the swirl-inducing body, and the nozzle insert can be made separately and installed in a simple manner. Service and maintenance works become easy because by simply unscrewing the nozzle insert, the swirl-inducing body can be removed and all nozzle components can then easily be cleaned. The swirl-inducing body is easy to install in the nozzle body, when, according to another feature of the present invention, the cavity is configured in the form of a bore extending from outside to the inside, with the swirl-inducing body abutting a wall of the cavity, or when the cavity is configured in the form of a stepped bore, with the swirl-inducing body being supported by a step of the cavity.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic fragmented sectional view of a spray nozzle according to the present invention disposed upon a mixing head lance;

FIG. 2 is a perspective sectional cutaway view of the spray nozzle of FIG. 1; and

FIG. 3 is an exploded perspective view of the spray nozzle of FIG. 2.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

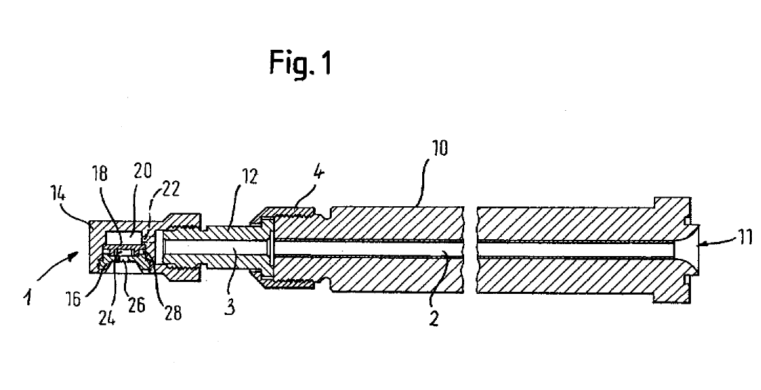

Turning now to the drawing, and in particular to FIG. 1, there is shown a schematic fragmented sectional view of a spray nozzle according to the present invention, generally designated by reference numeral 1, for attachment to a mixing head lance 10 which is connectable at its rearward end 11 to an unillustrated mixing head of a polyurethane assembly. An exemplary construction and manner in which a spray nozzle can be operatively and functionally incorporated into a polyurethane assembly is described, for example, in U.S. Pat. No. 5,028,006 to De Winter et al., the entire specification and drawings of which are expressly incorporated herein by reference. Typically, a mixing head of this type receives two reactive starting materials, such as polyol and isocyanate. These materials are mixed together in the mixing head and then discharged. The spray nozzle is hereby used to apply the reactive discharge mixture onto a surface where the discharge material reacts out and forms a plastic skin. The skin may be formed with a profiled or otherwise structured surface in dependence on the desired surface characteristics. The skin may be further processed through back injection molding or back foaming to exhibit a decorative surface.

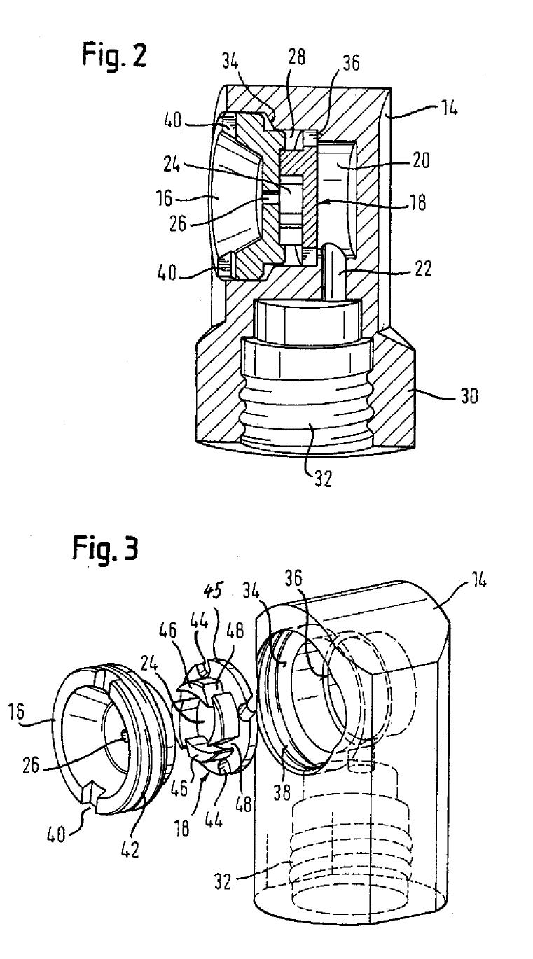

Production of a polyurethane skin of high quality requires discharge material to be sprayed upon the surface with optimum distribution and optimum droplet size. This can be realized by attaching the spray nozzle 1 to the lower end of the mixing head lance 10 via an adapter 12 which is mounted to the downstream end of the mixing head lance 10 and secured by a union nut 4. Using the mixing head lance 10 allows spaying of areas that are otherwise inaccessible by the mixing head. The mixing head lance 10 is formed with a central flow channel 2 through which discharge material from the mixing head flows via an aligned flow channel 3 of the adapter 12 to the spray nozzle 1. On its downstream end, the adapter 12 is formed with an external thread for threaded engagement of a nozzle body 14 of the spray nozzle 1. The nozzle head 14 has hereby an attachment flange 30 which is formed with an internal thread 32 (FIG. 2) for engagement to the outer thread of the adapter 12.

The spray nozzle 1 has a substantially cylindrical configuration and is formed with a stepped bore which extends perpendicular to the length axis of the spray nozzle 1 and is comprised of two steps, i.e. outer step 34 and inner step 36. The stepped bore narrows via the steps 34, 36 from outside to inside, with the steps 34, 36 forming annular shoulders or supports.

As shown in FIG. 2, a swirl-inducing body 18 is supported radially outwards on the inner step 36 and is held in place by a nozzle insert 16 against the step 36. The nozzle insert 16 has a substantially disk or cup-shaped configuration with a central nozzle bore 26 and is formed about its radial outer circumference with a thread 42 (FIG. 3) for threaded engagement of the nozzle insert 16 with an internal thread 38 of the stepped bore. When the nozzle insert 16 is fully screwed in, the lower end of the nozzle insert 16 abuts the swirl-inducing body 18 to secure the latter firmly in place within the nozzle body 14.

As shown in particular in FIG. 3, the swirl-inducing body 18 has a substantially disk-shaped central base 45 having four through openings 44 in the form of grooves about its periphery. The through openings 44 are configured at an incline in relation to the vertical upon the base 45. An annular web 46 is arranged on the base 45 and has at least one groove 48, here four grooves 48 by way of example, which extend from radially outwards inwardly. The grooves 48 may have a straight or helical configuration. The annular web 46 has a base-distal top surface which is flat enough to fit snugly on the underside of the nozzle insert 16. Formed within the annular web 46 is a swirl chamber 24 which ports into the nozzle bore 26.

The nozzle insert 16 is further provided with two anchoring grooves 40 for attachment of a suitable tool to loosen or tighten the nozzle insert 16 for detachment or attachment thereof.

The mode of operation of the nozzle according to the present invention is as follows. Reactive discharge material is fed from the mixing head via the central channels 2, 3 of the mixing head lance 10 and the adapter 12, respectively, to the spray nozzle 1. The reactive material flows inside the spray nozzle 1 via a material feed 22 of the nozzle body 14 into an inlet chamber 20 upstream of the swirl-inducing body 18. The material flows from the inlet chamber 20 via the through openings 44 into an annular space 28 defined radially outwards of the annular web 46 between the nozzle insert 16, the base 45 of the swirl-inducing body 18, and the nozzle body 14, as shown in particular in FIG. 3.

As the material passes the through openings 44 to enter the annular space 28, a first swirling action is already imparted to the material. In view of the circumferential offset disposition of the through openings 44 and the grooves 48 that traverse the annular web 46, the material is forced to flow in the annular space 28 in circumferential direction, resulting in imposition of a further swirling action upon the discharge material.

Subsequently, the material enters the swirl chamber 24 via the grooves 48. As the material flows through the grooves 48, the swirling effect is further enhanced. The material in the swirl chamber 24 is thus caused to swirl as it flows via the through openings 44, the annular channel 28, and the grooves 48 before exiting the swirl chamber 24 via the nozzle bore 26 to the ambient environment. The imparted swirling motion results in an optimum configuration of the spray cone with superior distribution of droplets as far as size is concerned and as far as the shape of the spray cone is concerned. As a result, a nozzle according to the present invention is simple in structure, easy to clean and cost-effective to make while yet attaining optimum spray results.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A nozzle for a spray head, in particular a polyurethane mixing head, said nozzle comprising:
a nozzle body having a cavity receiving discharge material via a material feed;
a swirl-inducing body accommodated in the nozzle body and having a disk or plate-shaped base constructed to include an annular web and at least one through opening arranged radially outside the annular web to provide a passage in fluid communication with the material feed, wherein the annular web is breached by a groove extending radially from an outer circumference to an inner circumference; and
a nozzle insert disposed on the swirl-inducing body and having a nozzle bore via which the discharge material is sprayed out,
wherein the base and the nozzle insert define radially outside of the annular web an annular channel which is fluidly connected to the through opening,
wherein a swirl chamber is formed radially within the annular web for fluidly connecting the swirl chamber with the annular channel via the groove, and
wherein the swirl chamber is covered by the nozzle insert such that discharge material is able to exit the swirl chamber via the nozzle bore during operation.

2. The nozzle of claim 1, wherein the groove is helical.

3. The nozzle of claim 1, wherein the groove is straight.

4. The nozzle of claim 1, wherein the base has a plurality of said through openings disposed in circumferential spaced-apart relationship of the base.

5. The nozzle of claim 4, wherein the through openings are arranged about the circumference in equal spaced-apart relationship.

6. The nozzle of claim 4, wherein the through openings are configured in the form of circumferential grooves.

7. The nozzle of claim 4, wherein the through openings extend at an incline in relation to a vertical upon the base so that the discharge material is introduced in circumferential direction of the annular channel with a swirling motion.

8. The nozzle of claim 1, wherein the annular web is breached by a plurality of said grooves.

9. The nozzle of claim 7, wherein the annular web is breached by a plurality of said grooves defined by an orientation, wherein the incline of the through openings and the orientation of the grooves have a same swirl-generating direction.

10. The nozzle of claim 4, wherein the annular web is breached by a plurality of said grooves, wherein the through openings are placed in circumferential offset relationship to the grooves.

11. The nozzle of claim 1, wherein the nozzle insert is constructed for threaded engagement into the nozzle body.

12. The nozzle of claim 1, wherein the cavity is configured in the form of a bore extending from outside to inside, with the swirl-inducing body abutting a wall of the cavity.

13. The nozzle of claim 1, wherein the cavity is configured in the form of a stepped bore extending from outside to inside, with the swirl-inducing body being supported by a step of the cavity.

14. The nozzle of claim 1, wherein the cavity is restrained in the nozzle body by the nozzle insert.

15. The nozzle of claim 1, wherein the discharge material is expelled through the nozzle bore in a discharge direction substantially perpendicular to a length axis of the nozzle body.

16. The nozzle of claim 1, wherein the swirl-inducing body and the nozzle insert have a single-piece configuration.

17. The nozzle of claim 1 for use for a spray head of a polyurethane mixing head.

18. A nozzle for a spray head, comprising:
a nozzle body;
a swirl-inducing body accommodated in the nozzle body and having a disk or plate-shaped base, which is formed with a circumferential through opening, and an annular web, which is connected to the base and defines a swirl chamber, said annular web having a radial groove for fluidly connecting a material feed with the swirl chamber via the through opening, thereby realizing a substantially radial discharge transfer of material through the groove of the annular web into the swirl chamber for imparting a swirling motion to the material; and
a nozzle insert disposed on the swirl-inducing body to bound the swirl chamber in opposition to the swirl-inducing body and having a nozzle bore via which the material is expelled in a substantially axial direction.

19. The nozzle of claim 18, wherein the through opening and the groove are placed in circumferential offset relationship and fluidly connected by an annular channel located radially outwards of the annular web between the nozzle insert, the base of the swirl-inducing body, and the nozzle body to further enhance the swirling motion on the material.

20. A polyurethane mixing head, comprising:
a mixing head lance receiving a discharge material; and
a spray head mounted to the mixing head lance and having a nozzle, said nozzle comprising a nozzle body having a cavity receiving discharge material via a material feed, a swirl-inducing body accommodated in the nozzle body and having a disk or plate-shaped base constructed to include an annular web and at least one through opening arranged radially outside the annular web to provide a passage in fluid communication with the material feed, wherein the annular web is breached by a groove extending radially from an outer circumference to an inner circumference, and a nozzle insert disposed on the swirl-inducing body and having a nozzle bore via which the discharge material is sprayed out, wherein the base and the nozzle insert define radially outside of the annular web an annular channel which is fluidly connected to the through opening, wherein a swirl chamber is formed radially within the annular web for fluidly connecting the swirl chamber with the annular channel via the groove, and wherein the swirl chamber is covered by the nozzle insert such that discharge material is able to exit the swirl chamber via the nozzle bore during operation.
